(19) United States
(12) Patent Application Publication
(10) Pub. No.: US 2026/0328140 A1
(43) Pub. Date: Oct. 22, 2026

(54) SHAFTS WITH CLUTCH PLATE DUST EVACUATION FEATURES FOR AIRCRAFT SYSTEMS

(71) Applicant: Rolls-Royce Corporation, Indianapolis, IN (US)

(72) Inventor: Andrew D. Copeland, Indianapolis, IN (US)

(21) Appl. No.: 19/183,282

(22) Filed: Apr. 18, 2025

(51) Int. Cl. F02C 7/36; B64C 29/00; F02C 7/052

(52) U.S. Cl. CPC F02C 7/36; F02C 7/052; B64C 29/0058; F05D 2220/328; F05D 2220/90; F05D 2260/4023

(57) ABSTRACT

A clutch assembly adapted for use with a gas turbine engine of an aircraft includes a rotatable input shaft coupled to the gas turbine engine, a rotatable output shaft coupled to a driven aircraft component and having a common axis of rotation with the input shaft, and a clutch plate stack arranged in a chamber formed radially between the input shaft and the output shaft. The clutch plate stack is configured to selectively couple the input shaft and the output shaft to transmit power from the gas turbine engine to the driven aircraft component.

### STATEMENT REGARDING FEDERALLY SPONSORED RESEARCH OR DEVELOPMENT

Embodiments of the present disclosure were made with government support under Contract No. N00019-20-C-0011. The government may have certain rights.

### FIELD OF THE DISCLOSURE

The present disclosure relates generally to clutch assemblies for aircraft engines, and more specifically to dust evacuation for clutch assemblies for aircraft engines.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

A clutch assembly may selectively couple the shaft of the gas turbine engine to a fan such as a vertical lift fan to transfer power from the gas turbine engine to the vertical lift fan when engaged. Such clutches designed for use in high power systems may include multiple clutch plates that engage one another such that friction between clutch plates transmits rotation through the clutch when engaged. In such designs, clutch plates may wear over time creating debris within the clutch assembly.

### SUMMARY

The present disclosure may comprise one or more of the following features and combinations thereof.

A clutch assembly adapted for use with a gas turbine engine of an aircraft may include an input shaft, an output shaft, and a clutch plate stack arranged in a chamber formed radially between the input shaft and the output shaft. The input shaft may be coupled to the gas turbine engine. The output shaft may be coupled to a driven aircraft component. The output shaft may have a common axis of rotation with the input shaft. The clutch plate stack may be configured to selectively couple the input shaft and the output shaft to transmit power from the gas turbine engine to the driven aircraft component.

In some embodiments, the rotatable output shaft may be formed to define a plurality of dust evacuation holes spaced apart circumferentially around the axis of rotation. Each of the dust evacuation holes may extend radially and circumferentially through the output shaft in the same direction as the rotation of the clutch assembly. Each of the dust evacuation holes may extend radially and circumferentially through the output shaft in the same direction as the rotation of the clutch assembly so that when the output shaft rotates about the axis of rotation, air within the chamber is driven out of the chamber through the plurality of dust evacuation holes to carry dust from wearing of the clutch plate stack out of the chamber to reduce buildup within the clutch assembly.

In some embodiments, each evacuation hole of the plurality of dust evacuation holes may have a tapered inlet. each evacuation hole of the plurality of dust evacuation holes may have a tapered inlet to encourage the dust in the chamber to flow out through the plurality of dust evacuation holes.

In some embodiments, the plurality of dust evacuation holes may each extend radially and circumferentially through the output shaft at an angle. The plurality of dust evacuation holes may each extend radially and circumferentially through the output shaft at an angle between about 15 degrees and about 45 degrees. The plurality of dust evacuation holes may each extend radially and circumferentially through the output shaft at an angle of about 15 degrees. The plurality of dust evacuation holes may each extend radially and circumferentially through the output shaft at an angle of about 30 degrees. The plurality of dust evacuation holes may each extend radially and circumferentially through the output shaft at an angle of about 45 degrees.

In some embodiments, the plurality of dust evacuation holes may include a first set of evacuation holes and a second set of evacuation holes. The first set of evacuation holes may be spaced apart circumferentially around the axis of rotation and aligned with a first radial plane. The second set of evacuation holes may be spaced apart circumferentially around the axis of rotation and aligned with a second radial plane. The second radial plane may be spaced apart axially from the first radial plane.

In some embodiments, a diameter of each hole of the first set of evacuation holes may be different than a diameter of each hole of the second set of evacuation holes. In some embodiments, a diameter of each hole of the first set of evacuation holes may be the same as a diameter of each hole of the second set of evacuation holes.

In some embodiments, the plurality of dust evacuation holes may further include a third set of evacuation holes. The third set of evacuation holes may be spaced apart circumferentially around the axis of rotation and aligned with a third radial plane. The third radial plane may be spaced apart axially from the first and second radial planes.

In some embodiments, a diameter of each hole of the third set of evacuation holes may be different than a diameter of each hole of the first set of evacuation holes or each hole of the second set of evacuation holes. In some embodiments, a diameter of each hole of the third set of evacuation holes may be the same as a diameter of each hole of the first set of evacuation holes or each hole of the second set of evacuation holes.

In some embodiments, the output shaft may include a main shaft body and a shaft cover. The shaft cover may be couple to the main shaft body.

In some embodiments, the main shaft body may include a radially-extending wall, a first end portion, and a second end portion. The radially-extending wall may extend radially relative to the axis of rotation. The first end portion may extend axially aft from the radially-extending wall. The second end portion may extend axially forward from the radially-extending wall radially outward of the first end portion. The first end portion may be coupled to the driven aircraft component. The second end portion may be formed to include the plurality of dust evacuation holes.

In some embodiments, the radially-extending wall may be formed to include a plurality of inlet holes. The plurality of inlet holes may each extend axially through the radially-extending wall so that when the output shaft rotates about the axis of rotation, air is drawn into the chamber through the plurality of inlet holes.

In some embodiments, the clutch plates of the clutch plate stack may comprise primarily carbon materials.

According to another aspect of the present disclosure, an aircraft may include an airframe, a gas turbine engine, an accessory system, and a clutch assembly. The gas turbine engine may be configured to provide thrust for propelling the airframe. The accessory system may be configured to be driven by the gas turbine engine. The clutch assembly may be configured to selectively transmit rotation from the gas turbine engine to the accessory system.

In some embodiments, the clutch assembly may include an input shaft coupled to the gas turbine engine, an output shaft coupled to the accessory system and having a common axis of rotation with the input shaft, and a clutch plate stack. The clutch plate stack may be arranged in a chamber formed between the input shaft and the output shaft. The clutch plate stack may be configured to selectively couple the input shaft and the output shaft to transmit power from the gas turbine engine to the accessory system.

In some embodiments, the rotatable output shaft may be formed to define a plurality of dust evacuation holes. The plurality of dust evacuation holes may be spaced apart circumferentially around the axis of rotation. Each hole of the plurality of dust evacuation holes may extend radially and circumferentially through the output shaft in the same direction as the rotation of the clutch assembly so that when the output shaft rotates about the axis of rotation, air within the chamber is driven out of the chamber through the plurality of dust evacuation holes to carry dust from the clutch plate stack out of the chamber to reduce buildup within the clutch assembly.

In some embodiments, each evacuation hole of the plurality of dust evacuation holes may have a tapered inlet. Each evacuation hole of the plurality of dust evacuation holes may have a tapered inlet to encourage the dust in the chamber to flow out through the plurality of dust evacuation holes.

In some embodiments, the plurality of dust evacuation holes may each extend radially and circumferentially through the output shaft at an angle. Each hole of the plurality of dust evacuation holes may extend radially and circumferentially through the output shaft at an angle between about 15 degrees and about 45 degrees.

In some embodiments, the plurality of dust evacuation holes may include a first set of evacuation holes and a second set of evacuation holes. The first set of evacuation holes may be spaced apart circumferentially around the axis of rotation and aligned with a first radial plane. The second set of evacuation holes may be spaced apart circumferentially around the axis of rotation and aligned with a second radial plane. The second radial plane may be spaced apart axially from the first radial plane. In some embodiments, a diameter of each hole of the first set of evacuation holes is different than a diameter of each hole of the second set of evacuation holes.

In some embodiments, the output shaft may include a main shaft body and a shaft cover. The shaft cover may couple to the main shaft body.

In some embodiments, the main shaft body may include a radially-extending wall, a first end portion, and a second end portion. The radially-extending wall may extend radially relative to the axis of rotation. The first end portion may extend axially aft from the radially-extending wall. The second end portion may extend axially forward from the radially-extending wall radially outward of the first end portion. The first end portion may be coupled to the accessory system. The second end portion may be formed to include the plurality of dust evacuation holes.

In some embodiments, the radially-extending wall may be formed to include a plurality of inlet holes. Each hole of the plurality of inlet holes may extend axially through the radially-extending wall so that when the output shaft rotates about the axis of rotation, air is drawn into the chamber through the plurality of inlet holes.

In some embodiments, the clutch plates of the clutch plate stack may comprise primarily carbon materials.

In some embodiments, the accessory system may be configured to provide thrust for propelling the airframe upon receipt of rotation from the gas turbine engine through the clutch assembly. The accessory system may be a lift fan configured to produce thrust directed to provide lift for takeoff and landing of the aircraft.

These and other features of the present disclosure will become more apparent from the following description of the illustrative embodiments.

### BRIEF DESCRIPTION OF THE FIGURES

Features of the application will be better understood from the following detailed description when considered in reference to the accompanying drawings, in which:

FIG. 1 is a perspective view of an aircraft including propulsion system having a gas turbine engine that produces thrust and power to drive other systems, a lift fan that produces lift for take-off and landing, and a high power clutch configured to selectively transmit rotation from the gas turbine engine to the lift fan;

FIG. 2 is a perspective view of the propulsion system of FIG. 1 showing that the clutch is coupled between a driving shaft that extends from the gas turbine engine and a driven shaft that extends into the lift fan;

FIG. 3 is a perspective view of a portion of an output shaft included in the clutch of the propulsion system of FIG. 2 showing the output shaft is formed to include a plurality of dust evacuation holes spaced apart circumferentially around the axis of rotation that each extend radially and circumferentially through the output shaft in the same direction as the rotation of the clutch assembly so that when the output shaft rotates about the axis of rotation air within the chamber is driven out of the chamber through the plurality of dust evacuation holes to carry dust from wearing of the clutch plate stack out of the chamber to reduce buildup within the clutch assembly.

FIG. 4 is a cross-sectional view of a portion of the propulsion system of FIG. 2 showing the clutch includes a rotatable input shaft coupled to the gas turbine engine, the rotatable output shaft coupled to a driven aircraft component, i.e., the lift fan, and a clutch plate stack arranged in a chamber formed radially between the input shaft and the output shaft;

FIG. 5 is a perspective view similar to FIG. 3 showing the output shaft included in the clutch of FIG. 4, and further showing the plurality of dust evacuation holes includes multiple sets of evacuation holes spaced apart circumferentially around the axis of rotation and aligned with a respective radial plane that is perpendicular to the axis of rotation;

FIG. 6 is a side view of the output shaft of FIG. 5 showing the plurality of dust evacuation holes includes a first set of evacuation holes aligned with a first radial plane, a second set of evacuation holes aligned with a second radial plane spaced apart axially from the first radial plane, and a third set of evacuation holes aligned with a third radial plane space apart axially from the first and second radial planes;

FIG. 7 is a detail view of FIG. 5 showing each of the plurality of dust evacuation holes may have a tapered inlet to encourage the dust in the chamber to flow out through the plurality of dust evacuation holes;

FIG. 8 is a cross-sectional view of FIG. 7 showing each of the plurality of dust evacuation holes extends radially and circumferentially at an angle relative to the axis of rotation;

FIG. 9 is a cross-sectional view of FIG. 5 taking along line 9-9 showing the plurality of dust evacuation holes are spaced apart circumferentially about the axis of rotation, and further showing the output shaft may further include inlet holes that extend axially through the output shaft to allow for air to be drawn into the chamber of the clutch; and

FIG. 10 is a detail view of FIG. 9 showing each of the plurality of dust evacuation holes has the same diameter.

### DETAILED DESCRIPTION OF REPRESENTATIVE EMBODIMENTS

While the present invention can take many different forms, for the purpose of promoting an understanding of the principles of the invention, reference will now be made to the embodiments illustrated in the drawing and specific language will be used to describe the same. It will nevertheless be understood that no limitation of the scope of the invention is thereby intended. Any alterations and further modifications of the described embodiments, and any further applications of the principles of the invention as described herein, are contemplated as would normally occur to one skilled in the art to which the invention relates.

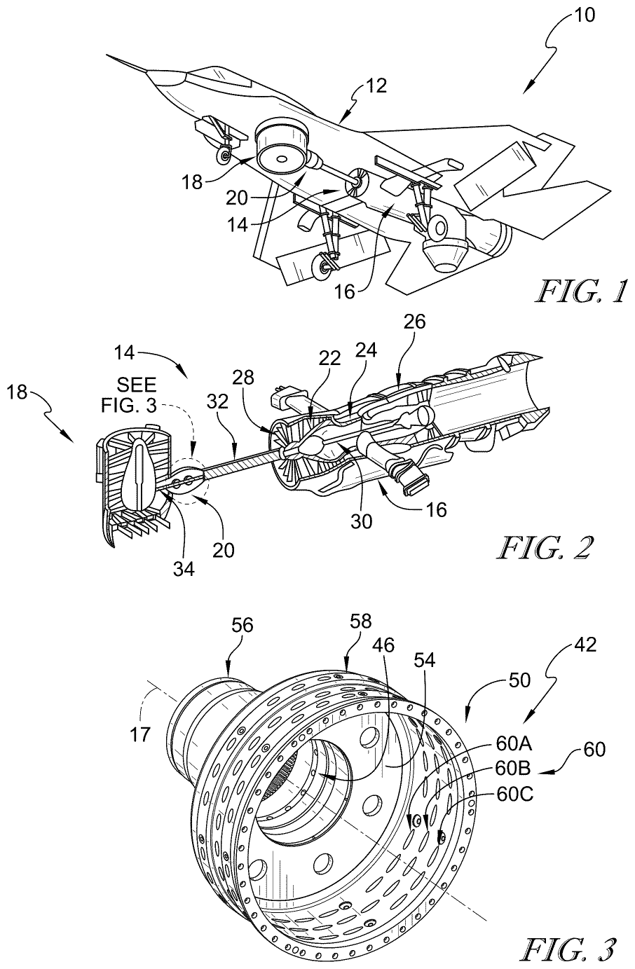

An aircraft 10 according to the present disclosure includes an airframe 12 and a propulsion system 14 as shown in FIGS. 1 and 2. The propulsion system 14 provides thrust to move the airframe 12 during takeoff, flight, and landing. The exemplary propulsion system 14 includes a gas turbine engine 16, a high-power accessory system 18, and the high-power clutch 20 as shown in FIGS. 1 and 2. The gas turbine engine 16 produces thrust for propelling the airframe 12 forward and power to drive the other systems 18, such as the lift fan 18. The lift fan 18 may produce thrust directed to provide lift for take-off and landing. The high-power clutch 20 is configured to selectively transmit rotation from the gas turbine engine 16 to the high-power accessory system 18.

The clutch assembly 20 is configured to selectively change between a disengaged mode and an engaged mode during use of the aircraft 10. The clutch 20 transmits power from the gas turbine engine 16 to the high-power accessory system 18, also referred to as a driven aircraft component, when the clutch 20 is engaged. When the clutch 20 is disengaged, power transmission is terminated and the gas turbine engine 16 no longer provides power to the high-power accessory system 18. The clutch 20 couples the gas turbine engine 16 as a driving component to the lift fan 18 as a driven component. However, the clutch 20 is not limited to such configuration, and other embodiments are contemplated. For example, the clutch 20 can be utilized in industrial applications, power generation applications, pumping sets, naval propulsion and other applications known to one of ordinary skill in the art. Further, it will be appreciated that the term “aircraft” as used herein includes, but is not limited to, helicopters, airplanes, unmanned space vehicles, fixed wing vehicles, variable wing vehicles, rotary wing vehicles, unmanned combat aerial vehicles, tailless aircraft, hover crafts, and other airborne and/or extraterrestrial (spacecraft) vehicles.

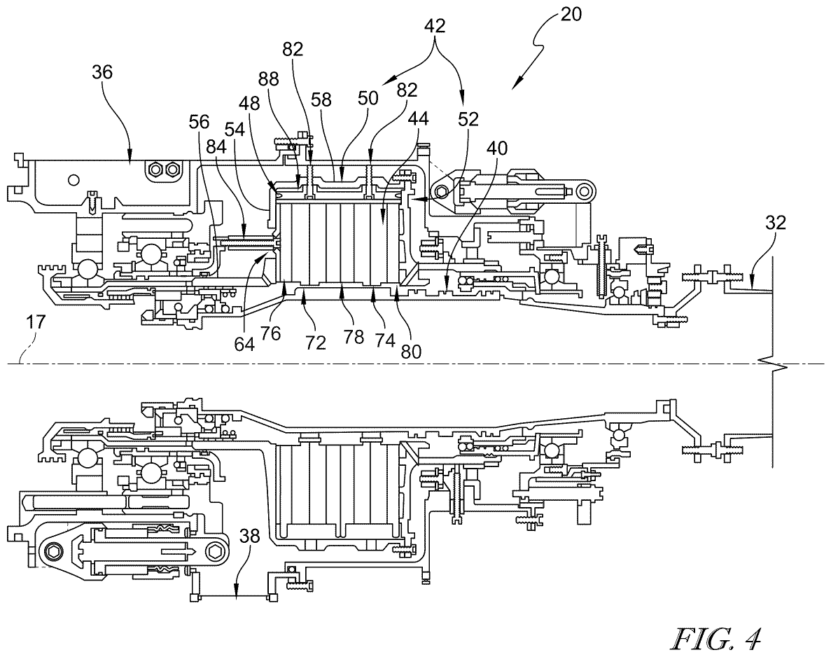

The clutch 20 includes a rotatable input shaft 40, a rotatable output shaft 42, and a clutch plate stack 44 as shown in FIG. 4. The input shaft 40 is arranged coaxially with the output shaft 42 so that the input shaft 40 and the output shaft 42 have a common axis of rotation 17. In these forms the shaft 42 can be used to drive the lift fan 18 and the shaft 40 can be driven by the aircraft engine 16. The clutch plate stack 44 is arranged in a chamber 48 formed radially between the input shaft 40 and the output shaft 42. The clutch plate stack 44 is configured to selectively couple the input shaft 40 and the output shaft 42 to transmit power from the gas turbine engine 16 to the lift fan 18.

In such embodiments, the clutch 20 may undergo a relatively high number of engagements (about 1,400 engagements over the life of the clutch 20) and absorb a relatively high horsepower (e.g., about 11,000 horsepower). The clutch plates in the clutch plate stack 44 may be made of a carbon/carbon composite material. As the clutch is engaged, the clutch plates wear and generate carbon dust. In some cases, wearing of the clutch plates may generate about 10 pounds or more of carbon dust over the course of the clutch assembly's life.

Due to the arrangement of the clutch plates, the dust may be trapped and accumulate within the clutch assembly. The accumulated dust may even interact with oil weeping from the oil sumps included therein, which creates a “sludge” within the clutch assembly. This buildup may cause an imbalance of the clutch assembly and high vibrations such that the clutch assembly may be removed and replaced early. Moreover, the buildup may result in more cultch overhauls which increases time, resources, and costs for these replacements.

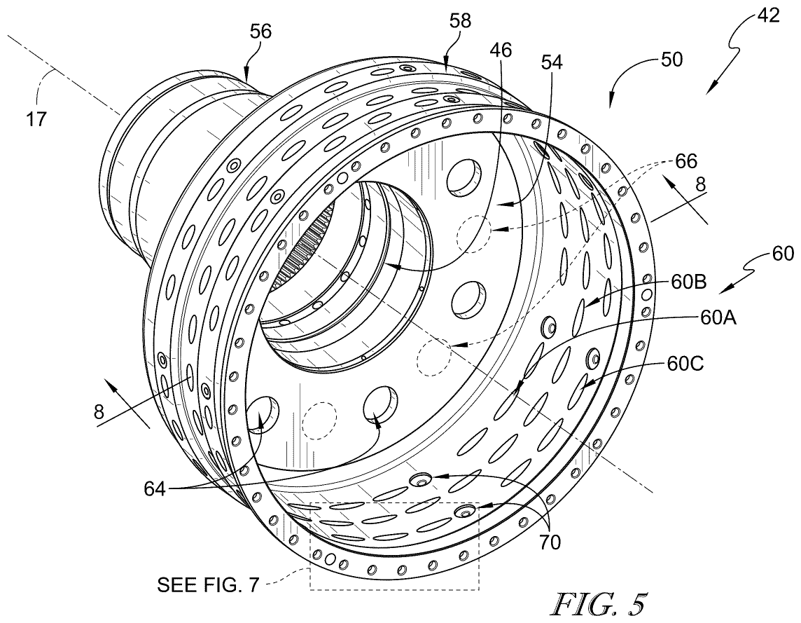

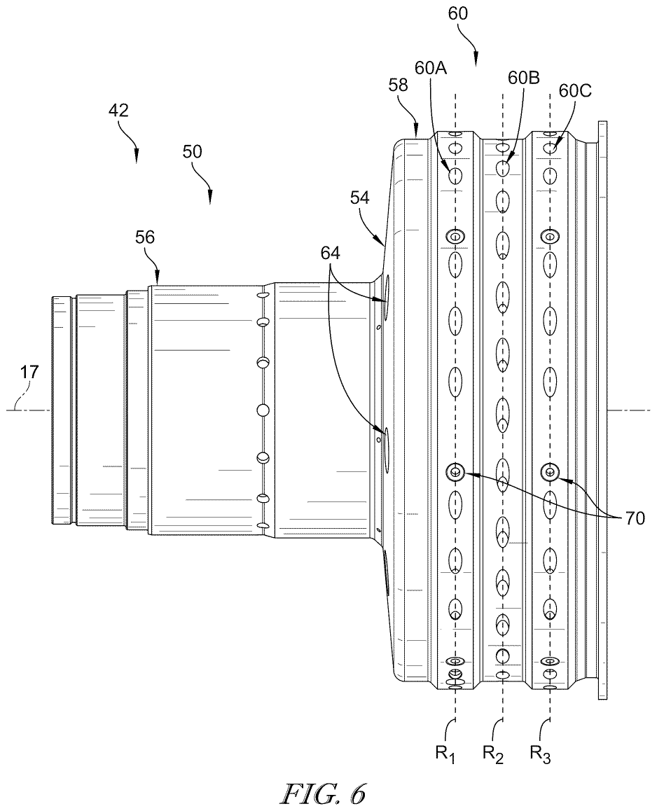

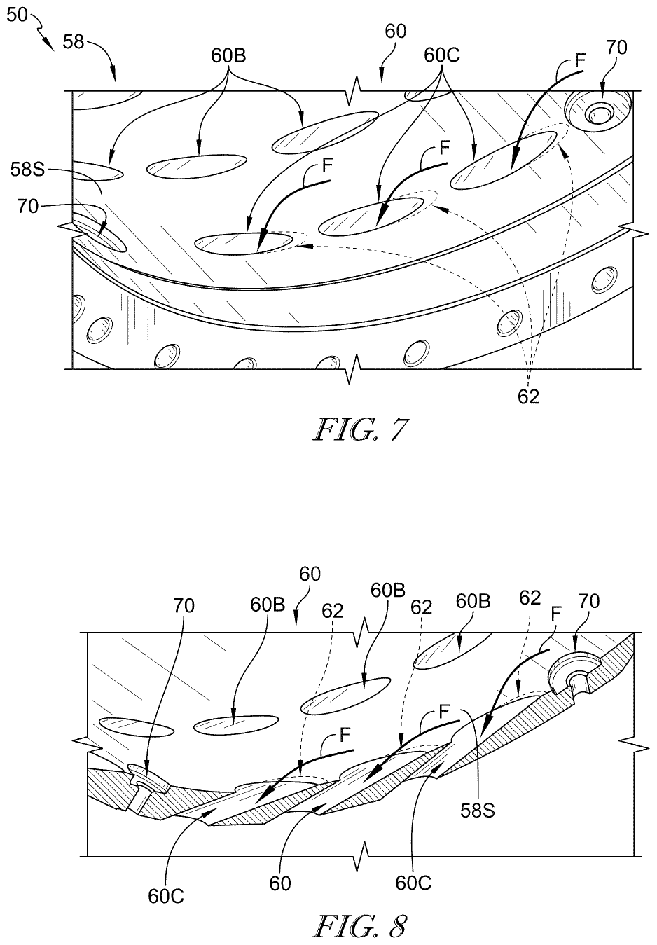

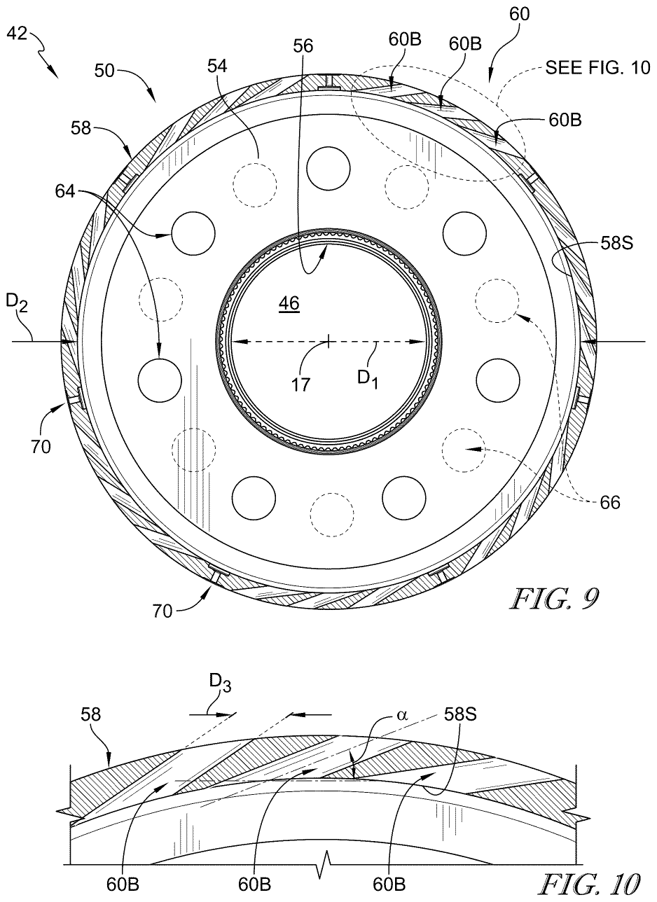

The clutch 20 of the present disclosure includes dust evacuation holes 60 in the output shaft 42 that are spaced apart circumferentially around the axis of rotation 17 and each extend radially and circumferentially through the output shaft 42 as shown in FIGS. 3-10. The holes 60 extend in a circumferential direction that is the same as the rotation of the input and output shafts 40, 42. In this way, when the output shaft 42 rotates about the axis of rotation 17, air within the chamber 48 is driven out of the chamber 48 through the dust evacuation holes 60, as suggested by arrows F in FIGS. 7 and 8. The air within the chamber 48 is driven out through the dust evacuation holes 60 to carry dust from clutch plate wear of the clutch plate stack 44 out of the chamber 48. The evacuation of the dust from the clutch plates of the clutch plate stack 44 reduces buildup within the clutch assembly 20 minimizing the risk of imbalance and vibration of the clutch 20 and increases the overall life of the clutch assembly 20.

Each of the plurality of dust evacuation holes 60 extends radially and circumferentially through the output shaft 42 at an angle α relative to the axis 17 as shown in FIG. 10. Each dust evacuation hole 60 has the same diameter D₃ as shown in FIG. 10. The diameter D₃ of each dust evacuation hole 60 is also constant as the hole 60 extends radially and circumferentially at the angle α. As discussed above, the angled holes 60 create a pumping effect to drive air within the chamber 48 is driven out through the dust evacuation holes 60 to carry dust from clutch plate wear of the clutch plate stack 44 out of the chamber 48.

As shown in FIGS. 3, 5, and 6, the plurality of dust evacuation holes 60 includes a first set of evacuation holes 60A, a second set of evacuation holes 60B, and a third set of evacuation holes 60C. The holes 60A of the first set of evacuation holes 60A are spaced apart circumferentially around the axis of rotation 17 and aligned with a first radial plane R₁. The holes 60B of the second set of evacuation holes 60B are spaced apart circumferentially around the axis of rotation 17 and aligned with a second radial plane R₂. The holes 60C of the third set of evacuation holes 60C are spaced apart circumferentially around the axis of rotation 17 and aligned with a third radial plane R₃. The first, second, and third planes R1, R2, R3 are spaced apart axially relative to the axis of rotation 17 and parallel to one another as shown in FIG. 6.

The dust evacuation holes 60A, 60B, 60C of each set of evacuation holes 60A, 60B, 60C all have the same diameter D₃ in the illustrative embodiments. In other embodiments, the diameter of each hole 60A of the first set of evacuation holes 60A may be different than the diameter of each hole 60B of the second set of evacuation holes 60B and/or each hole 60C of the third set of evacuation holes 60C. In some embodiments, the evacuation holes 60A, 60B, 60C of each set of evacuation holes 60A, 60B, 60C may each have different diameters.

As suggested in FIGS. 7 and 8, each evacuation hole 60 of the plurality of dust evacuation holes 60 may have a tapered inlet 62. An inner surface 58S of the output shaft 42 may be tapered to create the tapered inlet 62. In other words, the inner surface 58S of the output shaft 42 that defined an inner diameter of the output shaft 42 is tapered in an increasing radius just before each of the holes 60. The tapered inlet 62 encourages the dust in the chamber 48 to flow out through the plurality of dust evacuation holes 60.

With an initial description of the aircraft 10 provided above, the aircraft 10 is hereafter described in further detail. The aircraft 10 includes the airframe 12 and the propulsion system 14 as shown in FIGS. 1 and 2. The exemplary propulsion system 14 includes the gas turbine engine 16, the high-power accessory system 18, and the high-power clutch 20 as shown in FIGS. 1 and 2.

The gas turbine engine 16 includes a compressor section 22, a combustion section 24, and a turbine section 26. Airflow enters the gas turbine engine 16 and is compressed by the compressor section 22 before entering the combustion section 24 where it is mixed with fuel and burned before being expanded by the turbine section 26. A rotating shaft 30 connects the turbine section 26 to the compressor section 22 and serves to transfer power between the two. As will be appreciated, the gas turbine engine 16 can take a variety of forms such as, but not limited to, a turbofan, turbojet, turboshaft, and turboprop. Further, although the illustrated gas turbine engine 16 comprises a single spool engine, in another form the gas turbine engine 16 may comprise a multi-spool engine. In other embodiments, the gas turbine engine 16 may have other configurations suited to the particular application of the aircraft 10. For example, the gas turbine engine 16 can comprise a high bypass ratio (BPR) engine, an engine having a low pressure (LP) spool, among others.

A driveshaft 32 located upstream of the compressor section 22 (to the left in FIG. 1) is coupled to the rotating shaft 30 of the gas turbine engine 16 to draw rotational power from the gas turbine engine 16. The driveshaft 32 transfers rotational power to the clutch 20, which, in turn, can engage a shaft 34 of the driven component 18 to transmit power to the driven component 18. In the FIG. 1 embodiment, the driveshaft 32 is shown coupled to the upstream end of the rotating shaft 30; other configurations are also contemplated. In one form, the driveshaft 32 can take power from the rotating shaft 30 via a power take-off system in which for example the rotating shaft 30 takes power via a suitable bevel gear assembly at a location along the rotating shaft 30 in the combustion section 24, where the driveshaft 32 may be positioned transverse to the rotating shaft 30, for example.

The high-power accessory system 18 is a lift fan 18 of a short take off/vertical landing (STOVL) aircraft in the illustrative embodiment. Thus, for example, the clutch 20 can be used to selectively engage the shaft 34 of the lift fan 18 to the driveshaft 32 coupled to the aircraft gas turbine engine 16 to permit generation of lift from the lift fan 18 as desired. In other embodiments, the high-power accessory system 18 may be a generator, a fan, a gear assembly or series of gear assemblies, another clutch or series of clutches, or any other device or component that can utilize rotational power provided by the gas turbine engine 16 through the clutch 20.

The clutch assembly 20 includes a rotatable input shaft 40, a rotatable output shaft 42, and a clutch plate stack 44 as shown in FIG. 4. The input shaft 40 is coupled to the gas turbine engine 16, i.e., coupled to the driveshaft 32. The output shaft 42 is coupled to the driven component 18, i.e., the lift fan 18. In the illustrative form the input shaft 40 is smaller in diameter than the output shaft 42 and is thus located radially inward of the output shaft 42 such that the input shaft 40 extends through a center passage 46 formed by the output shaft 42. In this way, the output shaft 42 and the input shaft 40 share a common axis of rotation 17. The clutch plate stack 44 is arranged in the chamber 48 formed radially between the input shaft 40 and the output shaft 42. The clutch plate stack 44 is configured to selectively couple the input shaft 40 and the output shaft 42 to transmit power from the gas turbine engine 16 to the lift fan 18.

The output shaft 42 includes a main shaft body 50 and a shaft cover 52 coupled to the main shaft body 50 as shown in FIG. 4. The main shaft body 50 includes a radially-extending wall 54, a first end portion 56, and a second end portion 58 as shown in FIGS. 3-10. The radially-extending wall 54 extends radially relative to the axis of rotation 17. The first end portion 56 extends axially forward from the radially-extending wall 54 and the second end portion 58 extends axially aft from the radially-extending wall 54 radially outward of the first end portion 56. As such, the second end portion 58 has a diameter D₂ that is greater than a diameter D₁ of the first end portion 56.

The first end portion 56 is coupled to the lift fan 18, while the second end portion 58 is coupled to the shaft cover 52. The shaft cover 52 couples to the second end portion 58 to enclose the clutch plate stack 44 in the chamber 48. The chamber 48 between the input shaft 40 and the output shaft 42 is defined by input shaft 40, the radially-extending wall 54, the second end portion 58, and the shaft cover 52 as shown in FIG. 4. The second end portion 58 is formed to include the plurality of dust evacuation holes 60 so that the plurality of dust evacuation holes 60 open into the chamber 48.

The plurality of dust evacuation holes 60 extend radially and circumferentially through the second end portion 58 of the output shaft 42 in the same direction as the rotation of the clutch assembly 20 as shown in FIGS. 3-10. In this way, when the output shaft 42 rotates about the axis of rotation 17, air within the chamber 48 is driven out of the chamber 48 through the plurality of dust evacuation holes 60 to carry dust from wearing of the clutch plate stack 44 out of the chamber 48 to reduce buildup within the clutch assembly 20. When the output shaft 42 rotates, a pumping effect is generated to drive air within the chamber 48 out through the holes 60 which carries the dust therewith.

The holes 60 extend in a circumferential direction that is the same as the rotation of the input and output shafts 40, 42. In this way, when the output shaft 42 rotates about the axis of rotation 17, air within the chamber 48 is driven out of the chamber 48 through the dust evacuation holes 60 to carry dust from clutch plate wear of the clutch plate stack 44 out of the chamber 48. The evacuation of the dust from the clutch plates of the clutch plate stack 44 reduces buildup within the clutch assembly 20 minimizing the risk of imbalance and vibration of the clutch 20.

Each of the plurality of dust evacuation holes 60 extends radially and circumferentially through the output shaft 42 at an angle α relative to the axis 17. The angle α may be between about 15 degrees and about 45 degrees. In some embodiments, the angle α may be between about 30 degrees and about 45 degrees. α may be between about 15 degrees and about 30 degrees. In some embodiments, the angle α may be about 15 degrees. In some embodiments, the angle α may be about 30 degrees. In some embodiments, the angle α may be about 45 degrees.

Each dust evacuation hole 60 has the same diameter D₃ as shown in FIG. 10. The diameter D₃ of each dust evacuation hole 60 is also constant as the hole 60 extends radially and circumferentially at the angle α. In some embodiments, the diameter of the different dust evacuation holes 60 may vary between each of the holes 60. In some embodiments, the diameter D₃ of each dust evacuation hole 60 may vary as the hole 60 extends radially and circumferentially at the angle α.

As shown in FIGS. 3, 5, and 6, the plurality of dust evacuation holes 60 includes the first set of evacuation holes 60A, the second set of evacuation holes 60B, and the third set of evacuation holes 60C. The holes 60A of the first set of evacuation holes 60A are spaced apart circumferentially around the axis of rotation 17 and aligned with a first radial plane R₁. The holes 60B of the second set of evacuation holes 60B are spaced apart circumferentially around the axis of rotation 17 and aligned with a second radial plane R₂. The holes 60C of the third set of evacuation holes 60C are spaced apart circumferentially around the axis of rotation 17 and aligned with a third radial plane R₃. The first, second, and third planes R1, R2, R3 are spaced apart axially relative to the axis of rotation 17 and parallel to one another as shown in FIG. 6.

In some embodiments, the plurality of dust evacuation holes 60 only includes two sets of evacuation holes. In some embodiments, the plurality of dust evacuation holes 60 may have more than three sets of evacuation holes. The number or sets of evacuation holes 60 may vary depending on the air flow needed to evacuate or remove the dust in the chamber 48.

The dust evacuation holes 60A, 60B, 60C of each set of evacuation holes 60A, 60B, 60C all have the same diameter D₃ in the illustrative embodiments. In other embodiments, the diameter of each hole 60A of the first set of evacuation holes 60A may be different than the diameter of each hole 60B of the second set of evacuation holes 60B and/or each hole 60C of the third set of evacuation holes 60C. In some embodiments, the evacuation holes 60A, 60B, 60C of each set of evacuation holes 60A, 60B, 60C may each have different diameters.

As suggested in FIGS. 7 and 8, each evacuation hole 60 of the plurality of dust evacuation holes 60 may have the tapered inlet 62. The tapered inlet 62 encourages the dust in the chamber 48 to flow out through the plurality of dust evacuation holes 60. In some embodiments, some of the holes 60 may have a tapered inlet 62, while others do not. In some embodiments, the tapered inlet 62 of the different sets of dust evacuation holes 60A, 60B, 60C may be different. For example, the tapered inlet 62 of the holes 60 of the first set of dust evacuation holes 60A may have a smaller or larger tapered inlet 62 than the holes 60 of the second or third set of dust evacuation holes 60B, 60C.

In some embodiments, the clutch 20 may also include an outer housing 36 that extends around the input shaft 40, the output shaft 42, and the clutch plate stack 44 as shown in FIG. 4. The outer housing 36 may have a vent opening(s) 38 so that the dust evacuated from the chamber 48 through the plurality of dust evacuation holes 60 may be free to exit the clutch assembly 20.

The clutch plate stack 44 consists of a series of annular shape alternating clutch plates, also referred to as input plates 72, 74 and output plates 76, 78, 80. As will be appreciated, the number of clutch plates will depend on for example the rotational power transmission demands of the driven component 18 among other factors. The clutch 20 may also include various components on both the driving side and the driven side of the clutch plate stack 44, for example, components that interconnect the driveshaft 30 and the driven shaft 34 at respective opposite ends of the clutch 20, hydraulic engagement components that facilitate selective engagement and disengagement of the clutch 20, accessory drives, an accessory gear box, actuator components, shaft bearings, gears and gear components, working fluid pumps, fluid flow control valves, etc.

The input plates 72, 74 of the clutch plate stack 44 are slidably engaged with the input shaft 40 and are operable to be engaged with corresponding plates 76, 78, 80 associated with the output shaft 42. The input clutch plates 76, 78, 80 include friction surfaces on one or more of its sides, respectively. The friction surfaces of the sides can be any surface having attributes associated with abradable surfaces or wear surfaces in the brake, clutch, and/or transmission arts such as, but not limited to, toughness, strength, heat resistance, adequate frictional properties, and/or relatively long life. In some forms the friction surfaces can be textured, roughened, and/or grooved. The friction surfaces can be made from a carbon or carbon composite material.

The output clutch plates 76, 78, 80 of the clutch plate stack 44 are operable to be engaged with the input clutch plates 72, 74. The output clutch plates 76, 78, 80 include friction surfaces on one or more of its sides, respectively. The friction surfaces of the sides can be any surface having attributes associated with abradable surfaces or wear surfaces in the brake, clutch, and/or transmission arts such as, but not limited to, toughness, strength, heat resistance, adequate frictional properties, and/or relatively long life. In some forms the friction surfaces can be textured, roughened, and/or grooved. The friction surfaces can be made from a carbon or carbon composite material.

An output shaft lug key 88 is coupled to the output shaft 42 through attachment members or fasteners 82 as shown in FIG. 4. The attachment members 82 extend through apertures the output shaft lug key 88 and into/through apertures or holes 70 in the second end portion 58 of the output shaft 42 in the illustrative embodiment. The attachment members 82 may be bolts threadingly received in apertures formed in the output shaft lug key 88, but other forms of attachment members are contemplated herein. The apertures 70 in the second end portion 58 of the output shaft 42 extend radially therethrough at locations circumferentially around the axis 17. As shown in FIG. 3, the apertures 70 are aligned with the first and third sets 60A, 60C of the dust evacuation holes 60.

The output shaft lug key 88 maintains the relative clocked orientation of the output clutch plates 76, 78, 80 and is received in the illustrative embodiment by a keyway formed between in the outer periphery of the output clutch plates 76, 78, 80 as shown in FIG. 4. In other embodiments the output shaft lug key 88 may be received by apertures formed radially inward of the outer periphery of the output clutch plates 76, 78, 80. Although one output shaft lug key 88 is depicted, multiple lug keys 88 may be used. The output shaft lug key 88 permits the output clutch plates 76, 80 to slide relative to the output shaft lug key 88.

In a first, uncoupled state (disengaged), the input shaft 40 and the output shaft 42 are not coupled by the clutch plate stack 44. The output clutch plates 76, 78, 80 are in an uncompressed state and do not contact, or partially contact, the input clutch plates 72, 74. An actuator may be withdrawn and the output clutch plates 77, 78 and 80 axially separate naturally due to non-synchronous rotational speeds when left in the uncompressed state. Output clutch plates 77, 78 and 80 separate away from the other plates and out of contact with the input clutch plates 72, 74.

In a second, coupled state (engaged), the actuator may provide a force that moves a pressure plate axially in the direction of plate 76 and continues moving plate 76 such that it and all clutch plates 72, 74, 76, 78, 80 are compressed and synchronized. Compression of the output clutch plate 76 with the input clutch plate 72, the output clutch plate 78 with the input clutch plates 72, 74, and the input clutch plate 74 with the output clutch plate 80 engages the friction surfaces of the sides to couple rotation of the input shaft 40 with the output shaft 42.

The radially-extending wall 54 of the output shaft 42 is formed to include apertures 64 for the attachment members 84 for the pressure plate as shown in FIG. 4. The apertures 64 extend axially through the radially-extending wall 54 and open into the chamber 48. The attachment members 84 extend through the apertures 64 and into the pressure plate. In the illustrative embodiment, the radially-extending wall 54 of the output shaft 42 may also be formed to include additional apertures or holes 66 that extend axially through the radially-extending wall 54 circumferentially between apertures 64 or in low-stress regions of the radially-extending wall 54 of the output shaft 42 between the apertures 64. The apertures 66 allow for more airflow into the chamber 48.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A clutch assembly adapted for use with a gas turbine engine of an aircraft, the clutch assembly comprising:
an input shaft coupled to the gas turbine engine,
an output shaft coupled to a driven aircraft component and having a common axis of rotation with the input shaft, and
a clutch plate stack arranged in a chamber formed radially between the input shaft and the output shaft, the clutch plate stack configured to selectively couple the input shaft and the output shaft to transmit power from the gas turbine engine to the driven aircraft component,
wherein the rotatable output shaft is formed to define a plurality of dust evacuation holes spaced apart circumferentially around the axis of rotation that each extend radially and circumferentially through the output shaft in the same direction as the rotation of the clutch assembly so that when the output shaft rotates about the axis of rotation, air within the chamber is driven out of the chamber through the plurality of dust evacuation holes to carry dust from wearing of the clutch plate stack out of the chamber to reduce buildup within the clutch assembly, and
wherein each evacuation hole of the plurality of dust evacuation holes has a tapered inlet to encourage the dust in the chamber to flow out through the plurality of dust evacuation holes.

2. (canceled)

3. A clutch assembly adapted for use with a gas turbine engine of an aircraft, the clutch assembly comprising:
an input shaft coupled to the gas turbine engine,
an output shaft coupled to a driven aircraft component and having a common axis of rotation with the input shaft, and
a clutch plate stack arranged in a chamber formed radially between the input shaft and the output shaft, the clutch plate stack configured to selectively couple the input shaft and the output shaft to transmit power from the gas turbine engine to the driven aircraft component,
wherein the rotatable output shaft is formed to define a plurality of dust evacuation holes spaced apart circumferentially around the axis of rotation that each extend radially and circumferentially through the output shaft in the same direction as the rotation of the clutch assembly so that when the output shaft rotates about the axis of rotation, air within the chamber is driven out of the chamber through the plurality of dust evacuation holes to carry dust from wearing of the clutch plate stack out of the chamber to reduce buildup within the clutch assembly, and
wherein the plurality of dust evacuation holes each extend radially and circumferentially through the output shaft at an angle between about 15 degrees and about 45 degrees.

4. The clutch assembly of claim 1, wherein the plurality of dust evacuation holes includes a first set of evacuation holes spaced apart circumferentially around the axis of rotation and aligned with a first radial plane and a second set of evacuation holes spaced apart circumferentially around the axis of rotation and aligned with a second radial plane, wherein the second radial plane is spaced apart axially from the first radial plane.

5. A clutch assembly adapted for use with a gas turbine engine of an aircraft, the clutch assembly comprising:
an input shaft coupled to the gas turbine engine,
an output shaft coupled to a driven aircraft component and having a common axis of rotation with the input shaft, and
a clutch plate stack arranged in a chamber formed radially between the input shaft and the output shaft, the clutch plate stack configured to selectively couple the input shaft and the output shaft to transmit power from the gas turbine engine to the driven aircraft component,
wherein the rotatable output shaft is formed to define a plurality of dust evacuation holes spaced apart circumferentially around the axis of rotation that each extend radially and circumferentially through the output shaft in the same direction as the rotation of the clutch assembly so that when the output shaft rotates about the axis of rotation, air within the chamber is driven out of the chamber through the plurality of dust evacuation holes to carry dust from wearing of the clutch plate stack out of the chamber to reduce buildup within the clutch assembly,
wherein the plurality of dust evacuation holes includes a first set of evacuation holes spaced apart circumferentially around the axis of rotation and aligned with a first radial plane and a second set of evacuation holes spaced apart circumferentially around the axis of rotation and aligned with a second radial plane, wherein the second radial plane is spaced apart axially from the first radial plane, and
wherein a diameter of each hole of the first set of evacuation holes is different than a diameter of each hole of the second set of evacuation holes.

6. The clutch assembly of claim 4, wherein the plurality of dust evacuation holes further includes a third set of evacuation holes spaced apart circumferentially around the axis of rotation and aligned with a third radial plane, wherein the third radial plane is spaced apart axially from the first and second radial planes.

7. The clutch assembly of claim 6, wherein a diameter of each hole of the third set of evacuation holes is different than a diameter of each hole of the first set of evacuation holes or each hole of the second set of evacuation holes.

8. The clutch assembly of claim 1, wherein the output shaft includes a main shaft body and a shaft cover that couples to the main shaft body, wherein the main shaft body includes a radially-extending wall that extends radially relative to the axis of rotation, a first end portion that extends axially aft from the radially-extending wall, and a second end portion that extends axially forward from the radially-extending wall radially outward of the first end portion, the first end portion is coupled to the driven aircraft component, and the second end portion is formed to include the plurality of dust evacuation holes.

9. A clutch assembly adapted for use with a gas turbine engine of an aircraft, the clutch assembly comprising:
an input shaft coupled to the gas turbine engine,
an output shaft coupled to a driven aircraft component and having a common axis of rotation with the input shaft, and
a clutch plate stack arranged in a chamber formed radially between the input shaft and the output shaft, the clutch plate stack configured to selectively couple the input shaft and the output shaft to transmit power from the gas turbine engine to the driven aircraft component,
wherein the rotatable output shaft is formed to define a plurality of dust evacuation holes spaced apart circumferentially around the axis of rotation that each extend radially and circumferentially through the output shaft in the same direction as the rotation of the clutch assembly so that when the output shaft rotates about the axis of rotation, air within the chamber is driven out of the chamber through the plurality of dust evacuation holes to carry dust from wearing of the clutch plate stack out of the chamber to reduce buildup within the clutch assembly,
wherein the output shaft includes a main shaft body and a shaft cover that couples to the main shaft body, wherein the main shaft body includes a radially-extending wall that extends radially relative to the axis of rotation, a first end portion that extends axially aft from the radially-extending wall, and a second end portion that extends axially forward from the radially-extending wall radially outward of the first end portion, the first end portion is coupled to the driven aircraft component, and the second end portion is formed to include the plurality of dust evacuation holes, and
wherein the radially-extending wall is formed to include a plurality of inlet holes that each extend axially through the radially-extending wall so that when the output shaft rotates about the axis of rotation, air is drawn into the chamber through the plurality of inlet holes.

10. The clutch assembly of claim 1, wherein the clutch plates of the clutch plate stack comprise primarily carbon materials.

11. An aircraft comprising
an airframe,
a gas turbine engine configured to provide thrust for propelling the airframe,
an accessory system configured to be driven by the gas turbine engine, and
a clutch assembly configured to selectively transmit rotation from the gas turbine engine to the accessory system, the clutch assembly comprising:
an input shaft coupled to the gas turbine engine,
an output shaft coupled to the accessory system and having a common axis of rotation with the input shaft, and
a clutch plate stack arranged in a chamber formed between the input shaft and the output shaft, the clutch plate stack configured to selectively couple the input shaft and the output shaft to transmit power from the gas turbine engine to the accessory system,
wherein the rotatable output shaft is formed to define a plurality of dust evacuation holes spaced apart circumferentially around the axis of rotation that each extend radially and circumferentially through the output shaft in the same direction as the rotation of the clutch assembly so that when the output shaft rotates about the axis of rotation, air within the chamber is driven out of the chamber through the plurality of dust evacuation holes to carry dust from the clutch plate stack out of the chamber to reduce buildup within the clutch assembly, and
wherein each evacuation hole of the plurality of dust evacuation holes has a tapered inlet to encourage the dust in the chamber to flow out through the plurality of dust evacuation holes.

12. (canceled)

13. An aircraft comprising
an airframe,
a gas turbine engine configured to provide thrust for propelling the airframe,
an accessory system configured to be driven by the gas turbine engine, and
a clutch assembly configured to selectively transmit rotation from the gas turbine engine to the accessory system, the clutch assembly comprising:
an input shaft coupled to the gas turbine engine,
an output shaft coupled to the accessory system and having a common axis of rotation with the input shaft, and
a clutch plate stack arranged in a chamber formed between the input shaft and the output shaft, the clutch plate stack configured to selectively couple the input shaft and the output shaft to transmit power from the gas turbine engine to the accessory system,
wherein the rotatable output shaft is formed to define a plurality of dust evacuation holes spaced apart circumferentially around the axis of rotation that each extend radially and circumferentially through the output shaft in the same direction as the rotation of the clutch assembly so that when the output shaft rotates about the axis of rotation, air within the chamber is driven out of the chamber through the plurality of dust evacuation holes to carry dust from the clutch plate stack out of the chamber to reduce buildup within the clutch assembly, and
wherein the plurality of dust evacuation holes each extend radially and circumferentially through the output shaft at an angle between about 15 degrees and about 45 degrees.

14. The aircraft of claim 11, wherein the plurality of dust evacuation holes includes a first set of evacuation holes spaced apart circumferentially around the axis of rotation and aligned with a first radial plane and a second set of evacuation holes spaced apart circumferentially around the axis of rotation and aligned with a second radial plane, wherein the second radial plane is spaced apart axially from the first radial plane.

15. The aircraft of claim 14, wherein a diameter of each hole of the first set of evacuation holes is different than a diameter of each hole of the second set of evacuation holes.

16. The aircraft of claim 11, wherein the output shaft includes a main shaft body and a shaft cover that couples to the main shaft body, wherein the main shaft body includes a radially-extending wall that extends radially relative to the axis of rotation, a first end portion that extends axially aft from the radially-extending wall, and a second end portion that extends axially forward from the radially-extending wall radially outward of the first end portion, the first end portion is coupled to the accessory system, and the second end portion is formed to include the plurality of dust evacuation holes.

17. The aircraft of claim 16, wherein the radially-extending wall is formed to include a plurality of inlet holes that each extend axially through the radially-extending wall so that when the output shaft rotates about the axis of rotation, air is drawn into the chamber through the plurality of inlet holes.

18. The aircraft of claim 11, wherein the clutch plates of the clutch plate stack comprise primarily carbon materials.

19. The aircraft of claim 11, wherein the accessory system is configured to provide thrust for propelling the airframe upon receipt of rotation from the gas turbine engine through the clutch assembly.

20. The aircraft of claim 19, wherein the accessory system is a lift fan configured to produce thrust directed to provide lift for takeoff and landing of the aircraft.

21. The clutch assembly of claim 5, wherein the plurality of dust evacuation holes further includes a third set of evacuation holes spaced apart circumferentially around the axis of rotation and aligned with a third radial plane, wherein the third radial plane is spaced apart axially from the first and second radial planes.

22. The clutch assembly of claim 21, wherein a diameter of each hole of the third set of evacuation holes is different than a diameter of each hole of the first set of evacuation holes or each hole of the second set of evacuation holes.
